(19) United States
(12) Patent Application Publication
(10) Pub. No.: US 2008/0209437 A1
(43) Pub. Date: Aug. 28, 2008

(54) MULTITHREADED MULTICORE UNIPROCESSOR AND A HETEROGENEOUS MULTIPROCESSOR INCORPORATING THE SAME

(75) Inventor: Philip G. Emma, Danbury, CT (US)

Correspondence Address: CANTOR COLBURN LLP-IBM YORKTOWN, 20 Church Street, 22nd Floor, Hartford, CT, 06103, US

(73) Assignee: International Business Machines Corporation, Armonk, NY (US)

(21) Appl. No.: 12/118,958

(22) Filed: May 12, 2008

Related U.S. Application Data
(63) Continuation of application No. 11/465,247, filed on Aug. 17, 2006.

(51) Int. Cl. G06F 9/46

(52) U.S. Cl. 718/107

(57) ABSTRACT

A uniprocessor that can run multiple threads (programs) simultaneously is achieved by use of a plurality of low-frequency minicore processors, each minicore for receiving a respective thread from a high-frequency cache and processing the thread. A superscalar processor may be used in conjunction with the uniprocessor to process threads requiring high throughput.

### CROSS REFERENCE TO RELATED APPLICATION

This application is a continuation application of U.S. Ser. No. 11/465,247, filed Aug. 17, 2006, the contents of which are incorporated by reference herein in their entirety.

### TRADEMARKS

IBM™ is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention pertains to the field of computer architecture, and in particular, to multithreading—a technique wherein higher utilization (parallelism) is achieved by running multiple programs (threads) on a single processor simultaneously.

2. Description of the Related Art

Back in the 1960's, Control Data Corporation first implemented a processor that ran multiple independent programs simultaneously. This was an I/O (Input/Output) processor. They took advantage of the fact that the I/O processor was much faster than the I/O devices that it interacted with. So instead of building multiple processors to handle multiple I/O operations (which tend to be long) concurrently, they simply “time-sliced” the I/O processor so that it had the appearance of being multiple processors, each of them being much slower than the original physical processor, but better matched to the speeds of the I/O devices. Each device “thread” would then receive a slice of time on a strictly round-robin basis. For example, for 10 threads, each thread would get service every 10th cycle of the processor. In this way, a single hardware resource—the I/O processor—would provide far more value since it was much more highly utilized.

In the 1990s, most of the advances in processor microarchitecture revolved around extracting “Instruction Level Parallelism” (ILP) from a single thread. ILP encompassed the many ways in which “clever” hardware can execute multiple instructions of a program simultaneously, or “in parallel.” Many machines in the 1990started decoding four (or even more) instructions at the same time, and provided multiple execution elements so that four or more instructions could execute and be retired in a single cycle. These techniques were called “superscalar” techniques. Many of the superscalar mechanisms used to do this in the 1990s are still being designed into modem processors, although the focus on extracting the “last ounce” of parallelism from a single thread had abated as power has become a serious limitation on how much computation can be done within a given area. Getting very high parallelism in a superscalar processor requires having lots of available resources in the processor. For the resources to be available, they must necessarily be lightly utilized, hence inherently used inefficiently. At the same time, they burn power—even when not in use—via leakage currents.

As computer architecture evolved into the 21st century, the focus stopped being exclusively on single-thread performance. It became understood that many processors are used in server applications. In a server, there can be thousands of devices and people all connected, and all active simultaneously. In addition to being able to deliver high performance on a single program (thread), a server has to provide service to thousands of programs (threads) “simultaneously,” meaning on a time scale that appears “simultaneous” to humans. Servers usually have multiple processors (32 or 64, or even more), and their operating systems support “multiprogramming” environments in which multiple programs are all in progress “simultaneously.” Historically, operating systems provided this illusion by dispatching the numerous programs to the numerous processors, giving each program “time-slices” on the processors, and doing complex scheduling to ensure that all programs receive reasonable performance.

The current environment is one in which a processor must provide high performance to any single program, while at the same time, providing large thread-level parallelism, so that multiple programs enjoy high throughput. In the late 1990s, “multithreading” was (arguably) invented to take advantage of all of the underutilized resources in a superscalar processor. The thinking was that while running a primary thread at high performance, other threads could literally be running at the same time, using resources—sometimes on a cycle-by-cycle basis—not being used by the primary thread. The various permutations regarding how this has been managed and how threads have been prioritized have been described and investigated in numerous journals.

In the present day, multithreading is usually achieved by dynamic arbitration of a fixed set of resources in a uniprocessor. While now in the 21st century, the motivation is still basically the same as it was in the 1960s: to get better utilization of the existing resources. The evolution to multithreading came very naturally in the 1990s, since the “existing resources” in a processor became plentiful as superscalar implementations flourished.

Running multiple threads on a single processor requires three basic things. First, the thread's “state” has to be resident in order to achieve any kind of performance. By “state,” reference is specifically made the registers used by the thread. Roughly speaking, this means that support for N simultaneous threads is desired (called “N-way multithreading”), N times as many registers is needed in order to hold the state from the N threads. The larger register file is necessarily slower and almost certainly imposes a lower limit (than for a single thread) on the processor cycle time.

Second, within the processor, there needs to be additional multiplexing and manipulation of thread tags. Every instruction in the pipeline needs to have additional state to identify which thread it is from. Every multiplexer that selects inputs or chooses to post completion signals or exceptions has to select state that is relevant to the thread associated with the instruction, or post control information that clearly identifies the thread that is posting it. To do these things, it requires added multiplexing levels in many of the pipeline stages, hence it certainly imposes a lower limit (than for a single thread) on the processor cycle time.

And third, the processor requires thread-control hardware that makes decisions about when to incorporate which instructions from the various threads into the pipeline flow, and that makes sense out of the control signals that can emerge from any of the running threads at any point in the pipeline.

Two things should then be clear about the price that is paid for multithreading in exchange for what is gained by getting more “mileage” out of the hardware by providing service to multiple threads. First, since the register set must be larger, and since there must be additional levels of multiplexing in most stages of the processor pipeline, the multithreaded processor must have a slower cycle time, hence will deliver lower performance (than a non-threaded processor) on a single thread. Second, since the control state from multiple threads is all active simultaneously, and there are numerous interactions that are now possible, the multithreaded processor is necessarily more difficult to verify.

And one final thing—which is a little more subtle—will also be true. If a processor is going to be multithreaded, then the L1 cache must be made to provide more bandwidth (unless it was over designed in the first place), since it must now service the references from multiple threads running concurrently, where (ostensibly) the threads are not running much slower than they normally would. The L1 cache necessarily is having requests thrown at it at a higher rate, and it must be made to cope with them. Further, the L1 cache (at the same physical storage capacity) must now hold the working-sets of multiple threads. This means that each thread will necessarily have less of the L1 cache to itself, so the miss rates of all threads will be higher.

As is well known, the advancements in processor design have provided for great advancements in other technologies. However, there is continuing need for greater computing power. Therefore, what are needed are advancements in processor architecture, where a single processor provides improved support for multiple programs (threads).

### SUMMARY OF THE INVENTION

The shortcomings of the prior art are overcome and additional advantages are provided through the provision of a uniprocessor for processing a plurality of threads, the uniprocessor including: a plurality of N minicore processors, where N represents a number of minicores in the plurality, each minicore for processing a thread from the plurality of threads; and a cache for providing each thread from the plurality of threads to a respective minicore for processing of the thread; wherein an operating frequency for each minicore is less than an operating frequency of the cache.

Also disclosed is a multithreaded multicore uniprocessor as a part of a heterogeneous multiprocessor system, the system including: at least one multithreaded multicore uniprocessor and at least one non-threaded superscalar processor; wherein the uniprocessor includes a plurality of N minicores, where N represents a number of minicores in the plurality, each minicore for processing a thread from the plurality of threads; and a cache for providing each thread from the plurality of threads to a respective minicore for processing of the thread; wherein an operating frequency for each minicore is less than an operating frequency of the cache; and, wherein the superscalar processor includes a single thread core for processing a single thread.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a uniprocessor for processing a plurality of threads, includes: a plurality of N minicore processors, where N represents a number of minicores in the plurality, each minicore for processing a thread from the plurality of threads; wherein each minicore maintains a state that is separate from a state for the other minicores; wherein each minicore includes an instruction buffer for receiving instructions from a cache, an instruction decoder, a load and store unit to interact with the cache, a branch unit for at least one of resolving branches and redirecting instruction fetching, a general execution unit for performing instructions, and an interface to an accelerator; and the cache for providing each thread from the plurality of threads to a respective minicore for processing of the thread; wherein an operating frequency for each minicore is less than an operating frequency of the cache; and further including instructions for performing at least one of standard arbitration logic and time-sliced arbitration logic as well as reducing power to at least one minicore when the respective minicore is not in use.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a four-way multithreaded processor in accordance with prior art;

FIG. 2 depicts aspects of a four way multithreaded multicore uniprocessor in accordance with the current invention; and

FIG. 3 depicts aspects of a minicore processor used for processing a single thread in the multicore uniprocessor environment.

The detailed description explains the preferred embodiments of the invention, together with advantages and features, by way of example with reference to the drawings.

### DETAILED DESCRIPTION OF THE INVENTION

As discussed above, getting higher utilization out of the components of a processor for servicing multiple threads must account for three principles. First, the processor with a multithreaded core will have a degraded cycle time. Second, the multithreaded core will be more complex and more difficult to verify. Third, an L1 cache will have to be made to provide higher bandwidth to the processor.

The teachings herein ignore the prior emphasis on getting higher utilization from the elements of a prior art (usually superscalar) processor. In fact, as discussed, getting higher utilization adds considerable complexity and leads to a higher power density. The higher power density may not be tolerable in some environments.

The teachings herein provide for multithreading in a manner useful for providing a high-throughput uniprocessor. The techniques disclosed provide for design emphasis that opposes current multithreading design practices. The design provided herein uses redundant hardware and deliberately makes inefficient use of the hardware when efficiency is assessed in traditional terms.

The method and apparatus for a multithreaded uniprocessor is much simpler to design, build, and verify, than the multithreaded processors in the current art. One goal of the design is providing a high-throughput multithreaded uniprocessor as simply as possible. Advantageously, the design disclosed herein provides at least one additional benefit of a processor that operates at lower power.

In the teachings herein, a focus is only on high throughput of the processor. The disclosure provides a multiprocessor system that delivers high throughput and a superscalar non-threaded processor which delivers high single-thread performance through implementation of heterogeneity of design.

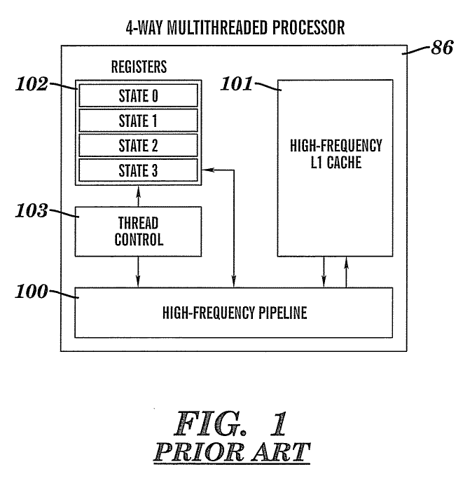

In one example of a prior art multithreaded processor, multiple copies of state (one per thread) are held in an expanded register set. Reference may be had to FIG. 1.

In FIG. 1, aspects of design concepts for a prior art 4-way multithreaded processor 86 are shown. The elements include a high-frequency pipeline 100, which conceptually is the original non-threaded pipeline augmented with the appropriate multiplexing to support multiple threads, a high-frequency Level-1 (L1) cache 101 which, had it been taken from an original non-threaded processor, has likely been augmented to provide the higher bandwidth that will be required by the multiple threads, a 4-times larger register set 102, which holds the four sets of state shown (one per thread) and a control function called “thread control” 103.

Since the processor pipeline 100 is assumed to be a high-frequency pipeline, the larger register set 102 poses a challenge to cycle time. In addition, the thread control 103, including design time, verification, and timing is complex, since four threads can be processed simultaneously. Note also, that since this is a high-frequency pipeline 100, it is likely highly segmented and hence has many stages. Therefore, additional complex control mechanisms (e.g., branch prediction) are also required to avoid large pipeline penalties for the running threads. The exemplary prior art multithreaded processor 86 provides throughput of four threads and the high-frequency pipeline 100 is commonly considered to deliver high processing performance for any single thread.

Design of the uniprocessor disclosed herein emphasizes targeting a transaction processing environment where single-thread performance is not required. This emphasis solves the problem of providing high throughput for multiple threads, while removing most of the complexity required in the prior art multithreaded processor 86. As a part of this simplification, the high frequency pipeline 100 is typically not included.

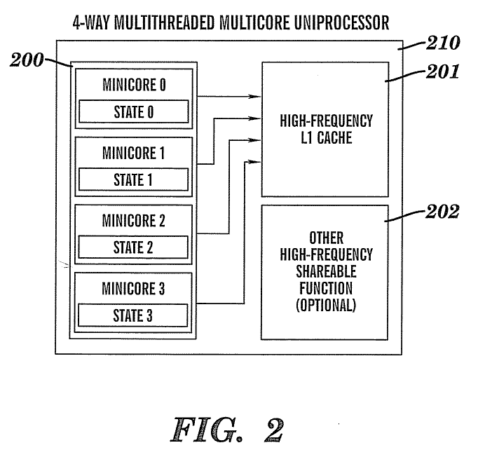

The uniprocessor according to the teachings herein retains the high frequency L1 cache 101. The L1 cache 101 is augmented to support the bandwidth of the multiple threads (as in the prior art), but instead of a large aggregate state running on the high frequency pipeline 100, multiple simple low-frequency cores are implemented, each core having its own state. Reference may be had to FIG. 2.

FIG. 2 depicts aspects of the uniprocessor 210. The exemplary embodiment includes a design for providing 4-way multithreading. Note that there is no high-frequency pipeline 100 as in the prior art multithreaded processor 86. Instead, there is a plurality of low-frequency “minicores” 200, one minicore 200 for each thread. Each minicore 200 maintains a copy of the state of a single thread. The plurality of minicores 200 share the high frequency L1 cache 201. In some respects, the L1 cache 201 is similar to the prior art high frequency L1 cache 101, as may become apparent later herein.

The L1 cache 201 of the uniprocessor 210 operates at a high frequency. Otherwise, the L1 cache 201 has a design that is similar to the prior art L1 cache 101. For example, the L1 cache 201 typically provides for management of traffic generated by the plurality of minicores 200 in the same manner as the prior art L1 cache 101 manages traffic from the high frequency pipeline 100. It may be considered in some respects that the prior art high frequency pipeline 100 and the plurality of minicores 200 generate similar reference patterns at comparable bandwidths which cannot easily be distinguished. In short, the L1 cache 201 of the uniprocessor 210 includes two important variations over the prior art, as will become apparent to those skilled in the art.

Another high-frequency component in the uniprocessor 210 is included (and labeled as “Other High Frequency Shareable Function” 202). However, the Other High Frequency Shareable Function 202 is not essential to the teachings herein and will be described later.

Referring to the example of FIG. 2, in some embodiments, each minicore 200 of the plurality runs at ¼ the frequency of the pipeline 100 being replaced. By having the high-frequency L1 cache 201, the bandwidth requirements of each minicore 200 is satisfied. Since each minicore 200 is tied to the L1 cache 201, coherency is handled automatically. Accordingly, for input and output considerations, the multicore uniprocessor 210 operates in a manner similar to other multithreaded uniprocessors.

The term “uniprocessor” 210 is considered appropriate as each of the minicores 200 share the L1 cache 201. Since sharing the L1 cache 201 means that there are no coherency issues between the minicores 200, it is a misnomer to refer to the plurality of minicores 200 as a multiprocessor. In operation, each of the minicores 200 is not explicitly visible when considering performance of the architecture or the software.

Ideally, each minicore 200 is as simple as possible, and runs at a relatively low frequency. For example, in the case of a 4-way multithreaded implementation, if the L1 cache 201 was designed for a 4 Gigahertz processor, each of the four minicores 200 would be designed to operate at 1 Gigahertz. For an 8-way multithreaded implementation, the uniprocessor 210 would use eight minicores, each running at 500 Megahertz.

Since each of the minicores 200 operate at a relatively low frequency, and use a simple design, a pipeline for each of the minicore 200 may be comparatively short. Use of a short pipeline enables elimination of any exotic ILP hardware mechanisms that would be required to eliminate stalls in a longer pipeline, where the cost of a stall is large. Elimination of all speculation, including branch predictors, renders the logic design of the minicore pipeline trivial. The low frequency objective and the small number of pipeline stages make the timing requirements much easier to achieve (than for a canonical high-speed pipeline). Further, verification is relatively trivial both because the minicores 200 are trivial, and because the threads do not interact, except perhaps at the L1 cache 201.

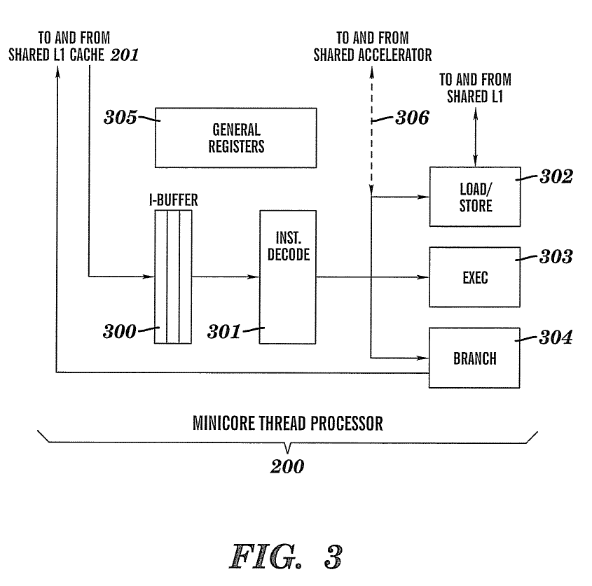

FIG. 3 depicts aspects of architecture for the minicore 200. The exemplary minicore 200 includes a small instruction buffer 300 which receives instructions from the shared L1 cache 201, an instruction decoder 301, a Load & Store Unit 302 which interacts with the shared L1 cache 201 to fetch and store operands, a Branch unit 304 to resolve branches and redirect instruction fetching, and a general Execution unit 303 to perform all other instructions. Note that the state for the resident thread is held in the general register file 305.

Note that no branch predictor is shown. The minicore processor 200 depicted in FIG. 3 could be as simple as a 2-stage Decode & Execute pipeline. In this embodiment, there is no real need for branch prediction. The rule would be that when a branch is encountered, the pipeline simply stops decoding for one cycle until the branch is resolved. The teachings herein do not preclude branch prediction, however branch prediction is not required. Of course, if the pipeline became longer (4 or 5 stages), branch prediction would have more value, but for the low-frequency operation of a minicore 200, a longer pipeline would be a less likely implementation.

Note that another path is shown in FIG. 3 and referred to as a “To & From Shared Accelerator” 306. The “To & From Shared Accelerator” 306 is shown as a dotted line, because it is optional. If it is the case that the Instruction Set Architecture contains hardware-intensive, but straightforwardly pipelineable elements (such as a Floating-Point instructions), these can be run at high frequency and shared—just like the L1 cache 201 is —if desired. Elements such as this do not have complex pipeline control problems between threads (e.g., the way an I-Unit would).

This optional path 306 is there to allow for algorithmically intensive shared function that preferably would not be replicated in each of the minicores 200. It could also pertain to a global branch prediction mechanism, if desired.

As mentioned in regard to the embodiment above, there are two basic ways to interface the plurality of minicores 200 to the high-frequency L1 cache 201. Note that the L1 cache 201 is very similar to the prior art L1 cache 101 used in the prior art multithreaded processor 86. Accordingly, it is a “given” that the L1 cache 201 has adequate bandwidth to support the plurality of minicores 200.

However, there are now multiple entities—the minicores 200—that are sending requests to the L1 cache 201. That is, while the request bandwidth is generally no different from the request bandwidth in the prior art implementation, there are now multiple physical entities making the requests. Therefore, there are more physical inputs to the L1 cache 201. These inputs must all be multiplexed down, and then arbitrated. There are two basic approaches to doing the arbitration.

A first technique for arbitration calls for using standard arbitration logic. Standard arbitration logic chooses from among the requests that could potentially be made on the same cycle. It does this in a manner that guarantees that every minicore 200 receives fair service. This is a well known art, and is used throughout computer systems wherever multiple entities come together to request a single resource.

The second technique for arbitration calls for a time-sliced approach. Previously, it was suggested that in an N-way multithreaded processor has N minicores 200, each minicore 200 operating at 1/N the frequency of the L1 cache 201. If the L1 cache 201 is able to accept requests at its native frequency, then the N minicores can each be phase-shifted by 1/N of the cycle time for the minicore 200.

Note that in the time-sliced approach, the N-way multithreaded processor need not run N minicores at a frequency of 1/N. For example, the frequency maybe about 1/N and not exactly 1/N. In fact, the frequency for each of the minicores may range considerably. More specifically, the frequency may range from (N-X)/N, where (N-X) is a non-zero positive number, to less than 1/N (that is, (N-X) may be a decimal number less than 1). In short, each minicore 200 runs at a lower frequency (i.e., is slower) than the L1 cache 201.

For example, consider a 4 Gigahertz L1 cache 201 that could accept requests on 250 picosecond boundaries. In this example, an 8-way multithreaded processor using 8 minicores 200 is called for, each minicore 200 running at 500 Megahertz, and each minicore 200 running 250 picoseconds behind its leftmost neighbor. In this way, each minicore 200 is allocated a unique time slot (of 250 picoseconds) for every one of its 2 nanosecond cycles. Keeping the minicores 200 phase-shifted in this way not only guarantees service by the L1 cache 201, but it minimizes inductive noise by distributing the 2 nanosecond “spikes” around the 2 nanosecond window in 250 picosecond increments.

In some server environments, it is desirable to not only provide high throughput, but also to provide high performance to certain threads when it is needed. Since the high frequency pipeline 100 of the prior art is eliminated from the current teachings, the current teachings regarding use of minicores 200 do not provide for high performance processing of any one thread.

In some embodiments, such as those where high performance processing is desired, a heterogeneous multiprocessor is provided. The heterogeneous multiprocessor may include a variety of types of sub-processors. For example, in the heterogeneous multiprocessor, a portion of the sub-processors are multithreaded multicore uniprocessors 210 as described herein, while some of the other sub-processors are non-threaded superscalar processors. In this way, when the heterogeneous multiprocessor system needs to provide a high rate of transaction processing, it can allocate numerous threads to the multithreaded multicore uniprocessor 210. Each of the threads will be allocated its own private physical minicore 200 on which it will run relatively slowly, although many such threads will be running simultaneously to provide high aggregate throughput.

When a particular thread demands high performance, the thread is dispatched to the non-threaded superscalar processor of the heterogeneous multiprocessor system, where it will be processed quickly. Note that in such embodiments, the non-threaded superscalar processor will run faster than any thread would run on a high-frequency multithreaded core, because there will be no overhead within the non-threaded processor (in the form of oversized register files, or additional levels of multiplexing). Therefore, the heterogeneous multiprocessor system offers various advantages not previously realized with prior art designs.

Referring again to the uniprocessor 210, since the minicores 200 are generally low-frequency cores, they need not be designed with aggressive circuit styles, and most paths will have large slack timings, and can be de-tuned for large power savings. Hence the minicores 200 should inherently run with good power efficiency. In addition, when less than all of the minicores 200 are in use, idle minicores 200 can be gated-off entirely, saving even more power. This provides a distinct advantage over the prior art multithreaded processor 86.

The capabilities of the present invention can be implemented in software, firmware, hardware or some combination thereof

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A uniprocessor for processing a plurality of threads, the uniprocessor comprising:
a plurality of N minicore processors, where N represents a number of minicores in the plurality, each minicore for processing a thread from the plurality of threads; and
a cache for providing each thread from the plurality of threads to a respective minicore for processing of the thread;
wherein an operating frequency for each minicore is less than an operating frequency of the cache.

2. The uniprocessor of claim 1, wherein each minicore maintains a state that is separate from a state for the other minicores.

3. The uniprocessor of claim 1, wherein each minicore comprises an instruction buffer for receiving instructions from the cache.

4. The uniprocessor of claim 1, wherein each minicore comprises an instruction decoder.

5. The uniprocessor of claim 1, wherein each minicore comprises a load and store unit to interact with the cache.

6. The uniprocessor of claim 1, wherein each minicore comprises a branch unit for at least one of resolving branches and redirecting instruction fetching.

7. The uniprocessor of claim 1, wherein each minicore comprises a general execution unit for performing instructions.

8. The uniprocessor of claim 1, wherein each minicore comprises an interface to an accelerator.

9. The uniprocessor of claim 1, comprising instructions for performing standard arbitration logic.

10. The uniprocessor of claim 1, comprising instructions for performing time-sliced arbitration logic.

11. The uniprocessor of claim 1, comprising instructions for reducing power to at least one minicore when the respective minicore is not in use.

12. The uniprocessor of claim 1, wherein the operating frequency of each minicore is about 1/N times the operating frequency of the cache.

13. A multithreaded multicore uniprocessor as a part of a heterogeneous multiprocessor system, the system comprising:
at least one multithreaded multicore uniprocessor and at least one non-threaded superscalar processor;
wherein the uniprocessor comprises a plurality of N minicores, where N represents a number of minicores in the plurality, each minicore for processing a thread from the plurality of threads; and a cache for providing each thread from the plurality of threads to a respective minicore for processing of the thread; wherein an operating frequency for each minicore is less than an operating frequency of the cache; and,
wherein the superscalar processor comprises a single thread core for processing a single thread.

14. The system of claim 13, further comprising instructions for providing a thread to one of the uniprocessor and the superscalar processor.
